(19) United States
(12) Patent Application Publication
(10) Pub. No.: US 2009/0096831 A1
(43) Pub. Date: Apr. 16, 2009

(54) INKJET RECORDING APPARATUS

(75) Inventors: Noriyuki Sugiyama, Kawasaki-shi (JP); Nozomu Nishiberi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/251,234

(22) Filed: Oct. 14, 2008

(30) Foreign Application Priority Data
Oct. 16, 2007 (JP) 2007-269159

(51) Int. Cl. B41J 23/00

(52) U.S. Cl. 347/37

(57) ABSTRACT

An inkjet recording apparatus includes a first support member fixed to a chassis and configured to guide the motion of a carriage, and a second support member provided farther from a platen than the first support member. The gap between a recording head and the platen is changed by moving the second support member.

### BACKGROUND OF THE INVENTION

1. Field of the Invention

The present invention relates to inkjet recording apparatuses including a movable carriage on which a recording head for performing recording by discharging ink onto a recording medium is mounted. More particularly, the present invention relates to an inkjet recording apparatus in which the gap between a platen for supporting a recording medium and a recording head is changeable.

2. Description of the Related Art

In recording apparatuses that perform recording by discharging ink from a recording head, a carriage on which the recording head is mounted is moved in a direction intersecting the conveying direction of a recording medium. The carriage reciprocates along a guide shaft serving as a main guide member and a guide member serving as a sub guide member. These recording apparatuses for discharging ink from the recording head perform recording not only on plain paper, but also on thick paper and disks such as CD-Rs. For this reason, the gap between the recording head and a platen for supporting a recording medium at a position facing the recording head is changed.

U.S. Pat. No. 6,899,474 discloses an inkjet recording apparatus in which a carriage with a recording head mounted thereon reciprocates while being guided and supported by a guide shaft and a guide rail. The inkjet recording apparatus also includes a platen that supports a recording medium at a position facing the recording head mounted on the carriage. The guide shaft is provided near the platen, and the guide rail is provided remote from the platen. Eccentric cams are provided at either end of the guide shaft. By transmitting the driving force of a carriage lifting motor to the eccentric cams via gear trains, the guide shaft is moved up and down.

Unfortunately, the invention taught in U.S. Pat. No. 6,899,474 has the following problem. Since the guide shaft moves up and down, it is urged by springs in order to avoid rattling. For this reason, when recording is performed with the recording head, the position of the guide shaft slightly changes. As a result, the landing position of ink discharged from the recording head onto the recording medium becomes unstable, and an image is distorted in high-quality image recording.

### SUMMARY OF THE INVENTION

The present invention provides an inkjet recording apparatus that can perform high-quality image recording by changing the position of a recording head relative to a platen for supporting a recording medium so as to change the gap therebetween.

An inkjet recording apparatus according to an aspect of the present invention includes a movable carriage having a recording head configured to perform recording by discharging ink onto a recording medium; a platen configured to support the recording medium at a position facing the recording head; a first support member fixed to a chassis, and configured to guide motion of the carriage; and a second support member provided farther from the platen than the first support member, and configured to guide the motion of the carriage in conjunction with the first support member. A gap between the recording head and the platen is changed by moving the second support member in a direction intersecting a surface of the platen for supporting the recording medium.

Further features of the present invention will become apparent from the following description of exemplary embodiments with reference to the attached drawings.

### BRIEF DESCRIPTION OF THE DRAWINGS

FIG. 1 is a perspective view of an inkjet recording apparatus according to a first embodiment of the present invention.

FIG. 2 is a perspective view showing an internal configuration of the inkjet recording apparatus.

FIG. 3 is a cross-sectional view of the inkjet recording apparatus when the gap between a recording head and a platen is small.

FIG. 4 is a side view of the inkjet recording apparatus when the gap between the recording head and the platen is small.

FIG. 5 is a cross-sectional view of the inkjet recording apparatus when the gap between the recording head and the platen is large.

FIG. 6 is a side view of the inkjet recording apparatus when the gap between the recording head and the platen is large.

FIG. 7 is an explanatory view showing a structure for fixing a first guide shaft to a chassis.

FIG. 8 is a control block diagram of the inkjet recording apparatus.

FIGS. 9A and 9B are graphs showing the displacement of the ink landing position in a conveying direction of a recording medium, respectively, when the first guide shaft is fixed to the chassis and when the first guide shaft is urged by springs, as in the related art.

FIG. 10 is a table showing the relationships among the carriage position, gap, eccentric cam phase, etc.

FIG. 11 is a cross-sectional view of an inkjet recording apparatus according to a second embodiment when the gap between a recording head and a platen is small.

FIG. 12 is a cross-sectional view of the inkjet recording head according to the second embodiment when the gap between the recording head and the platen is large.

FIG. 13 is an explanatory view showing a structure for moving a guide rail up and down in the second embodiment.

### DESCRIPTION OF THE EMBODIMENTS

Exemplary embodiments of the present invention will be specifically described below with reference to the drawings. Through the drawings, the same reference numerals denote the same or corresponding components.

### First Embodiment

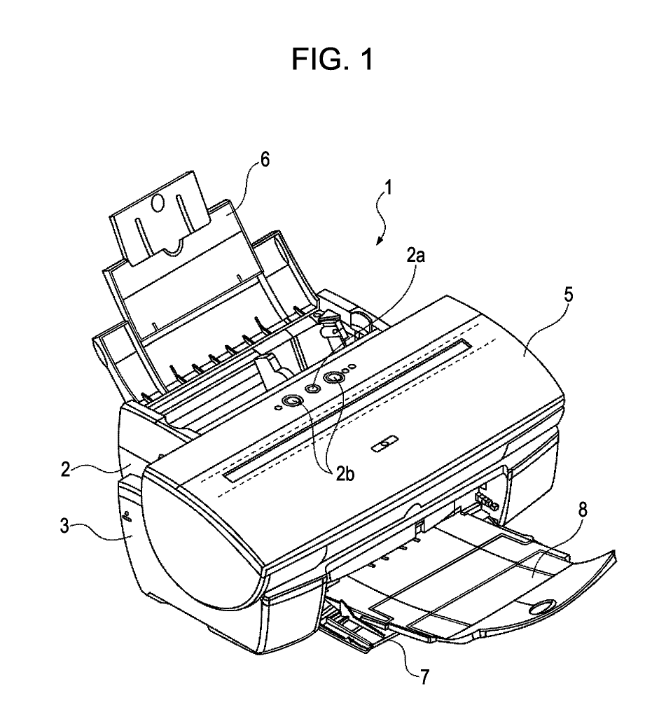

FIG. 1 is a perspective view of an inkjet recording apparatus 1 according to a first embodiment of the present invention. The inkjet recording apparatus 1 includes an upper case 2 and a base 3. The upper case 2 and the base 3 are connected and fixed by elastic fitting claws (not shown). An access cover 5 is openably and closably attached to the upper case 2. By opening the access cover 5, ink tanks and so on provided in the apparatus can be replaced. The upper case 2 is provided with an LED guide 2a, key switches 2b, etc. Further, a multistage paper feed tray 6 is openably and closably provided at the upper rear of the upper case 2. The paper feed tray 6 serves to cover the interior of the apparatus when not used. In contrast, during use, recording sheets can be set by opening and drawing out the paper feed tray 6.

The base 3 is provided with an openable and closable front cover 7. The front cover 7 opens and closes a paper output port for recording sheets. When the front cover 7 is opened, as shown in FIG. 1, an extensible paper output tray 8 can be drawn out.

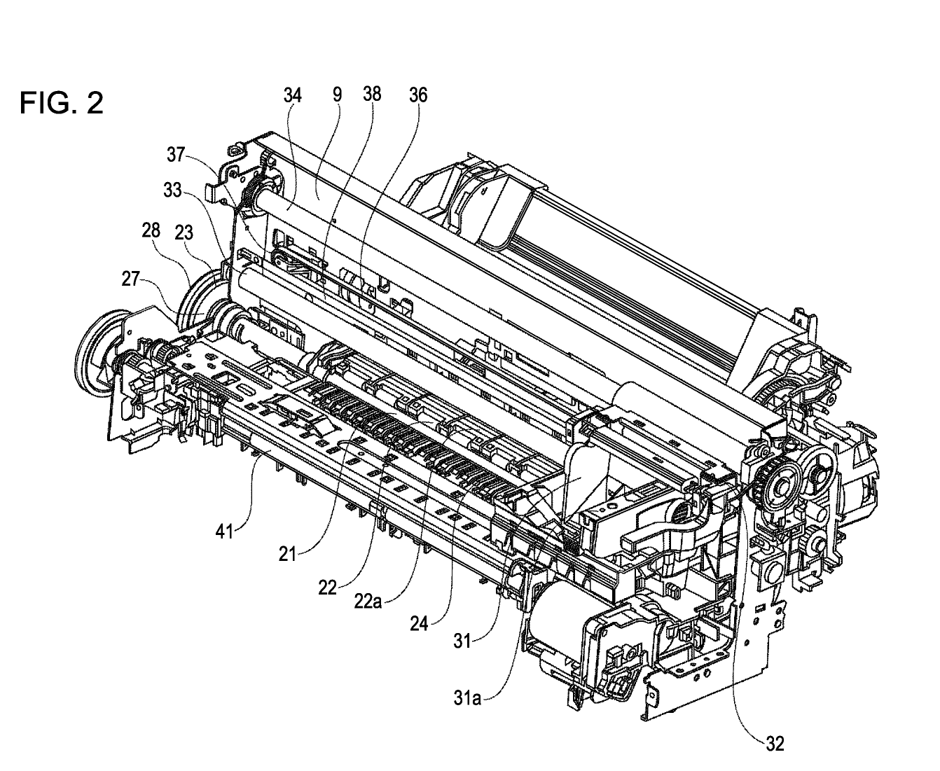

FIG. 2 is a perspective view showing an internal configuration of the inkjet recording apparatus 1. In the inkjet recording apparatus 1, components are assembled on a bent chassis 9. The inkjet recording apparatus 1 mainly includes a conveying unit 20, a carriage unit 30, and a paper output unit 40. These units will be described in order with reference to FIGS. 2 to 7.

### Conveying Unit

The conveying unit 20 includes a conveying roller 21 for conveying a recording medium. The conveying roller 21 is formed by a metal shaft having a surface coated with ceramic microparticles, and is supported at both ends on the chassis 9 by bearings. Compression springs are provided between the conveying roller 21 and the bearings. During rotation of the conveying roller 21, load is applied by the urging force of the springs, thus stabilizing the rotation. In the first embodiment, the conveying roller 21 has an outer diameter of about 11 mm.

A plurality of pinch rollers 22 are in contact with the conveying roller 21 while being urged by springs. The pinch rollers 22 rotate to follow the rotation of the conveying roller 21. Further, the pinch rollers 22 are held by a pinch roller holder 22a that is turnably supported by the chassis 9.

Near the entrance of the conveying unit 20, a guide flapper (not shown) for guiding the recording medium, and a platen 24 are provided. The platen 24 is positioned and fixed to the chassis 9. The pinch roller holder 22a is provided with a PE sensor lever for detecting leading and trailing edges of the recording medium.

The conveying roller 21 is driven by a conveying motor 26 serving as a DC motor. Driving of the driving motor 26 is transmitted to the conveying roller 21 via a timing belt 23 and a pulley 27. The conveying roller 21 is also provided with a code wheel 28 for detecting the amount of rotation of the conveying roller 21. The code wheel 28 has markings that are arranged at a pitch of 150 to 300 lpi. These markings are read by an encoder sensor (not shown).

A recording medium conveyed from the paper feed unit is conveyed on the platen 24 by the conveying roller 21 and the pinch rollers 22. The platen 24 has ribs 24a that form a conveyance reference plane for the recording medium. By the ribs 24a, a gap A between the recording head 31 and the platen 24 is managed, and waving of the recording medium is prevented.

### Carriage Unit

The carriage unit 30 includes a carriage 32 on which the recording head 31 is mounted. In the recording head 31, a plurality of ink tanks 31a are mounted removably. The recording head 31 also includes a plurality of discharge ports and heaters for heating ink. Heat generated by the heaters causes film boiling in ink. Ink is discharged from the discharge ports onto the recording medium by changes in pressure made by growth and contraction of bubbles due to film boiling.

A first guide shaft 33 and a second guide shaft 34 are supported on the chassis 9 so as to guide and support the motion of the carriage 32 in a direction intersecting the conveying direction of the recording medium. The first guide shaft 33 is provided on a side near the platen 24, and the second guide shaft 34 is provided on a side remote from the platen 24.

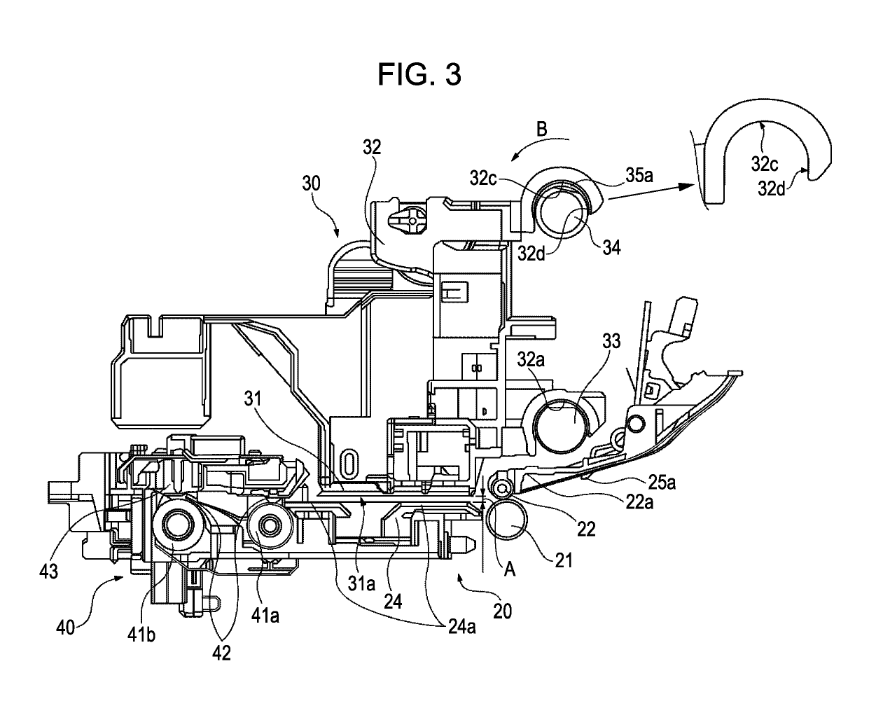

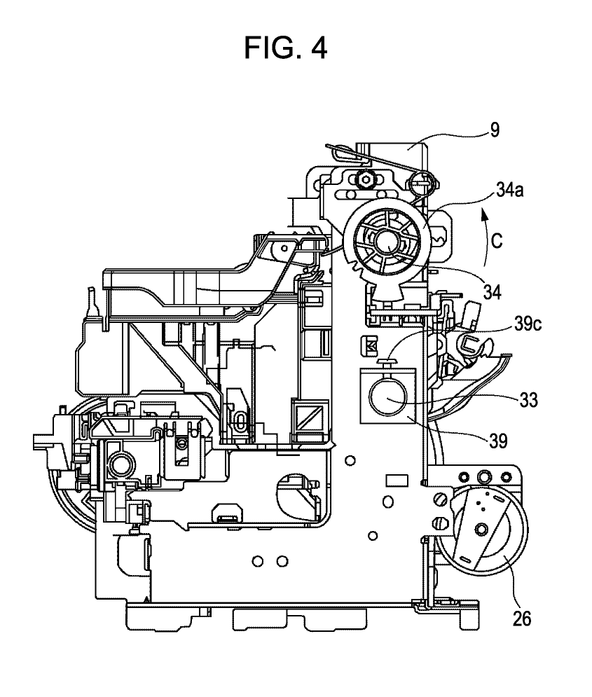

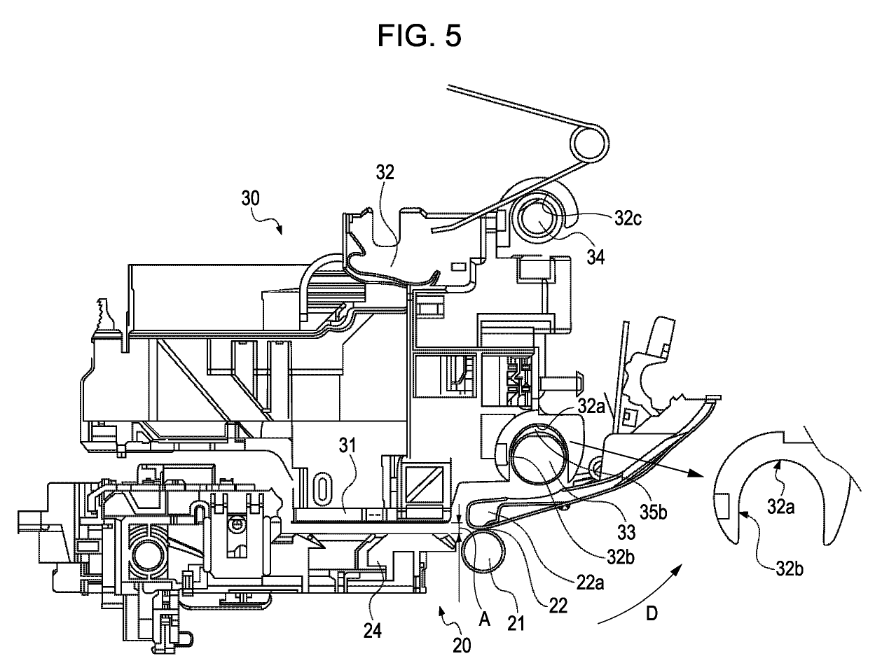

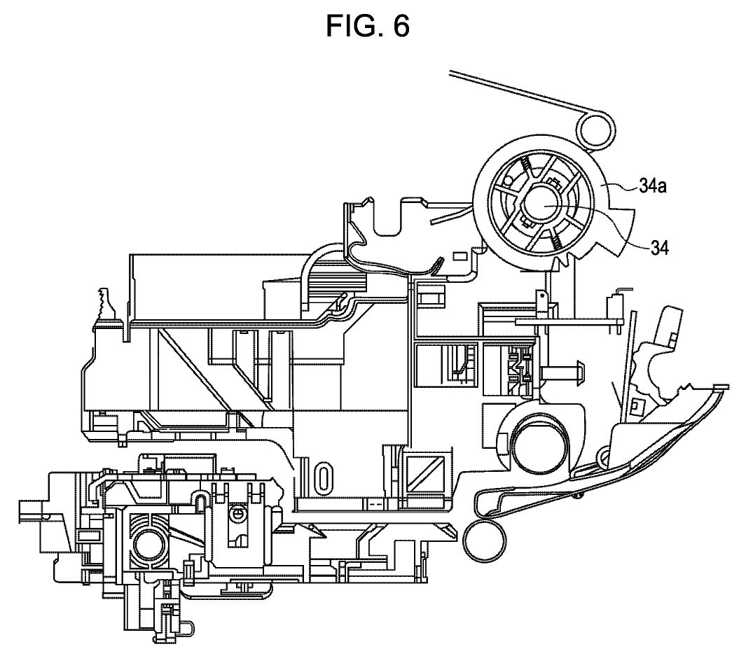

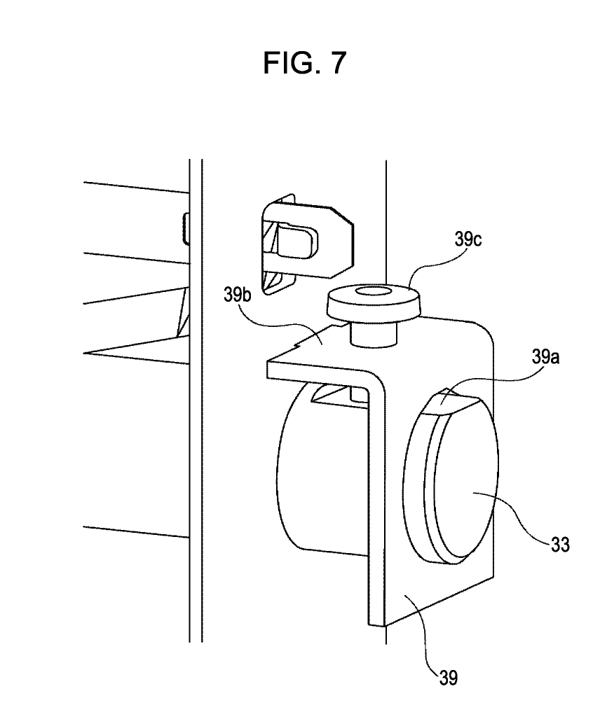

FIGS. 3 and 4 are a cross-sectional view and a side view, respectively, of the inkjet recording apparatus 1 when the gap A between the recording head 31 and the platen 24 is small (first gap). FIGS. 5 and 6 are a cross-sectional view and a side view, respectively, of the inkjet recording apparatus 1 when the gap A between the recording head 31 and the platen 24 is large (second gap). FIG. 7 explains a structure for fixing the first guide shaft 33 to the chassis 9.

First, the structure for fixing the first guide shaft 33 to the chassis 9 will be described with reference to FIG. 7. One end (left end, as viewed from the front of the apparatus) of the first guide shaft 33 is inserted in the chassis 9, and the other end (right end, as viewed from the front of the apparatus) of the first guide shaft 33 is fixed to the chassis 9 via a guide-shaft fixing member 39. The guide-shaft fixing member 39 includes a hole 39a in which the first guide shaft 33 is inserted, and a positioning portion 39b for positioning the first guide shaft 33 relative to the chassis 9. After the other end of the first guide shaft 33 is inserted in the hole 39a of the guide-shaft fixing member 39, a planar portion 33a of the first guide shaft 33 is pushed by the leading end of a screw 39c. The first guide shaft 33 is thereby pressed against the inner periphery of the hole 39a of the guide-shaft fixing member 39, and positioned.

The carriage 32 is driven by transmitting the driving of a carriage motor mounted on the chassis 9 thereto via a timing belt 36 (FIG. 2). The timing belt 36 is tensely supported by an idle pulley 37, and is coupled to the carriage 32 via a damper formed of rubber or the like. Vibration of the carriage motor is attenuated by the damper, and this reduces image unevenness due to vibration.

A code strip 38 (FIG. 2) for detecting the position of the carriage 32 extends parallel to the timing belt 36. The code strip 38 has markings arranged at a pitch of 150 to 300 lpi, and the markings are read by an encoder sensor mounted on a carriage substrate of the carriage 32. The carriage substrate includes contacts for electrical connection to the recording head 31, and a flexible substrate is connected thereto so as to exchange head signals with a main substrate.

The carriage 32 includes a first bearing 32a (FIG. 3) and a second bearing 32c respectively provided on both sides thereof in the moving direction. The first bearing 32a is engaged with the first guide shaft 33, and the second bearing 32c is engaged with the second guide shaft 34.

In a state shown in FIGS. 3 and 4 in which the gap A between the recording head 31 and the platen 24 is small, the position of the carriage 32 in the height direction is determined by the contact of the top of the first guide shaft 33 with the top of the first bearing 32a. In this case, the gap A between the recording head 31 and the platen 24 is set at 1.0 mm. In the height direction, the top of the second guide shaft 34 is separate from the top of the second bearing 32c so as to form a space 35a therebetween. In this case, the turning of the carriage 32 around the first guide shaft 33 in the direction of arrow B in FIG. 3 is regulated by the contact of a turn regulating portion 32d of the second bearing 32c with the second guide shaft 34.

Eccentric cams 34a are provided at either end of the second guide shaft 34. The second guide shaft 34 is urged by urging springs against adjustment plates that are fixed to the chassis 9. When the driving force of a carriage lifting motor is transmitted to the eccentric cams 34a via predetermined gear trains, the eccentric cams 34a rotate to move the second guide shaft 34 up and down.

By rotating the eccentric cams 34a in the direction of arrow C in FIG. 4, the state shown in FIGS. 3 and 4 in which the gap A between the recording head 31 and the platen 24 is small shifts to a state shown in FIGS. 5 and 6 in which the gap A between the recording head 31 and the platen 24 is large.

In the state shown in FIGS. 5 and 6 in which the gap A between the recording head 31 and the platen 24 is large, the position of the carriage 32 in the height direction is determined by the contact of the top of the second guide shaft 34 with the top of the second bearing 32c of the carriage 32 in the height direction. In this case, the gap A between the recording head 31 and the platen 24 is set at 1.2 mm. In the height direction, the top of the first guide shaft 33 is separate from the top of the first bearing 32a so as to form a space 35b therebetween. In this case, the turning of the carriage 32 around the second guide shaft 34 in the direction of arrow D in FIG. 5 is regulated by the contact of a turn regulating portion 32b of the first bearing 32a with the first guide shaft 33.

As described above, the first guide shaft 33 close to the platen 24 is fixed to the chassis 9, and the second guide shaft 34 remote from the platen 24 moves up and down, so that the gap A between the recording head 31 and the platen 24 can be changed.

In order to record an image on a recording medium with the recording head 31, the recording medium is conveyed to a recording line position by the conveying roller 21 and the pinch rollers 22, and the carriage 32 is moved by driving the carriage motor.

### Paper Output Unit

The paper output unit 40 includes two paper output rollers 41 (41a and 41b), spurs 42 (42a and 42b) rotating to follow the rotation of the paper output rollers 41, and a gear train for transmitting the driving force of the conveying motor 26 to the paper output rollers 41. The upstream paper output roller 41a is formed by a metal shaft with rubber, and is attached to the platen 24. To the upstream paper output roller 41a, the driving force of the conveying motor 26 is transmitted via an idler gear and so on. In contrast, the downstream paper output roller 41b is formed by a resin shaft with rubber, and is attached to the platen 24. To the downstream paper output roller 41b, the driving force of the upstream paper output roller 41a is transmitted via an idler gear and so on.

The spurs 42 are formed by molding an SUS thin plate having a plurality of convex portions on the periphery integrally with a resin portion, and are mounted on a spur base 43 via spur springs such as coil springs. The spurs 42 are pressed against the paper output rollers 41 by the urging forces of the spur springs.

After an image is recorded on a recording medium with the recording head 31 mounted on the carriage 32, the recording medium is conveyed by the paper output rollers 41 and the spurs 42, and is then output into the paper output tray 8.

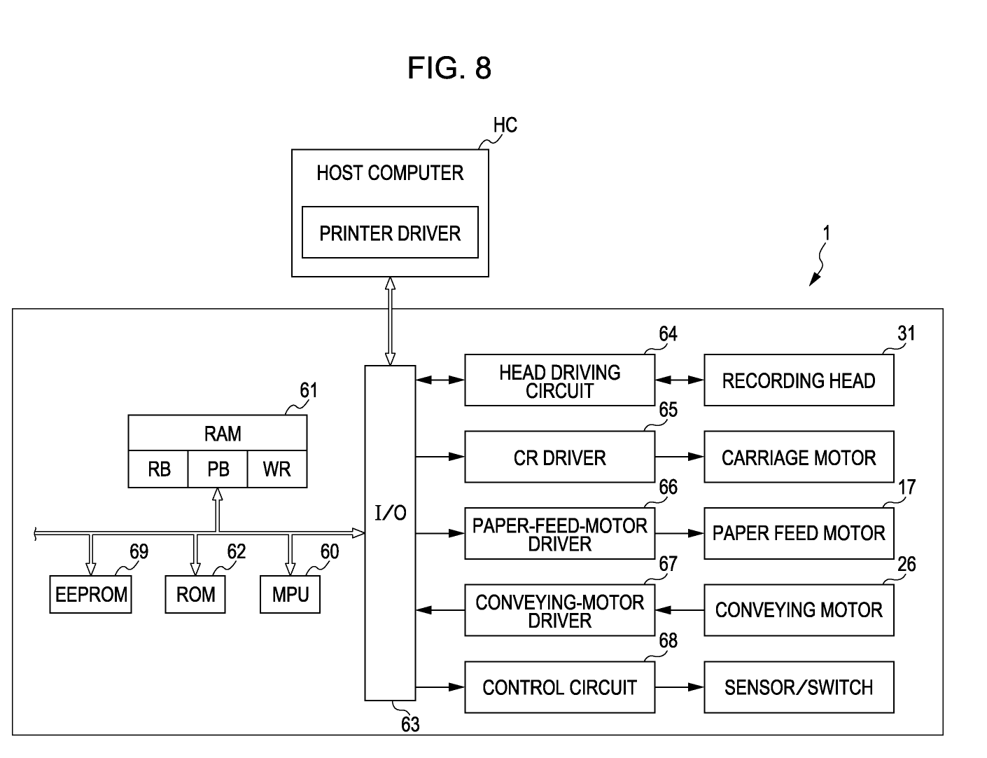

FIG. 8 is a control block diagram of the inkjet recording apparatus 1. The inkjet recording apparatus 1 includes an MPU 60 functioning as a unit for controlling the entire apparatus. The MPU 60 is connected to a RAM 61 and a ROM 62 via a bus line. The RAM 61 includes a receiving buffer RB for temporarily holding various data, a print buffer PB, and a work RAM WR used as a work area for calculation necessary for various control operations. The ROM 62 stores various control programs.

An input/output interface 63 is connected to the MPU 60 via the bus line, and is also connected to an external host computer HC. The recording head 31 is connected to the input/output interface 63 via a head driving circuit 64 so as to be controlled by the MPU 60. Similarly, the input/output interface 63 is connected to the carriage motor via a CR driver 65, to a paper feed motor 17 in the paper feed unit via a paper-feed-motor driver 66, and to the conveying motor 26 via a conveying-motor driver 67. Sensors and switches are connected to the input/output interface 63 via a control circuit 68. The inkjet recording apparatus 1 also includes an EEPROM 69.

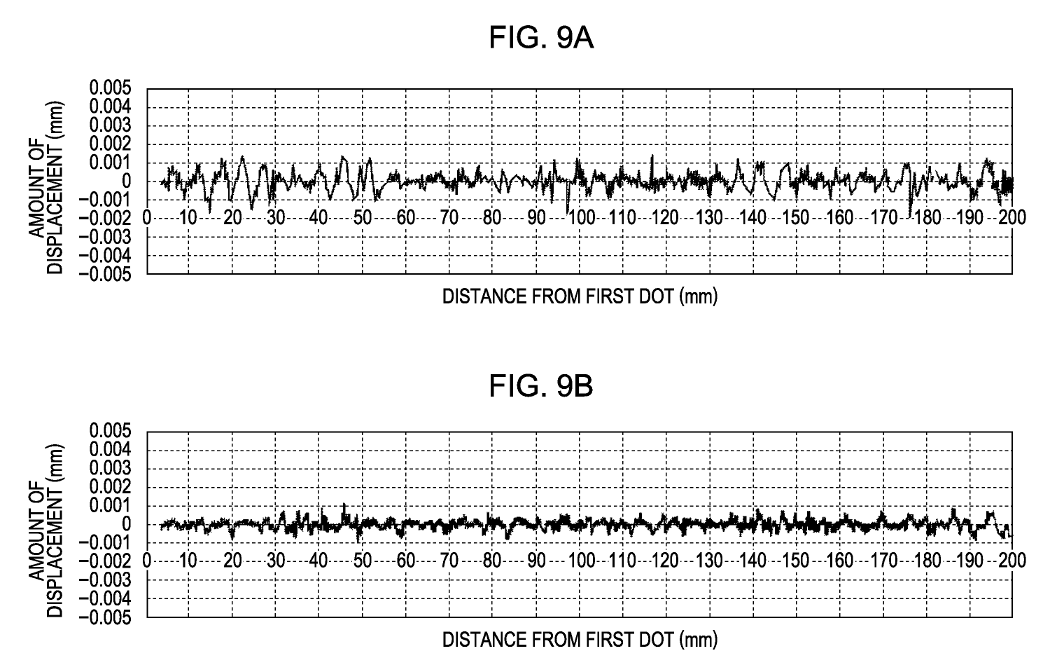

FIGS. 9A and 9B are graphs showing displacement of the ink landing position in the conveying direction of the recording medium, respectively, when the first guide shaft 33 is fixed to the chassis 9, as in the first embodiment and when the first guide shaft 33 is urged by springs, as in the related art. In this case, the gap A between the recording head 31 and the platen 24 is small, as shown in FIG. 3. FIGS. 9A and 9B show that the displacement of the ink landing position can be made smaller when the first guide shaft 33 is fixed to the chassis 9, as in the first embodiment.

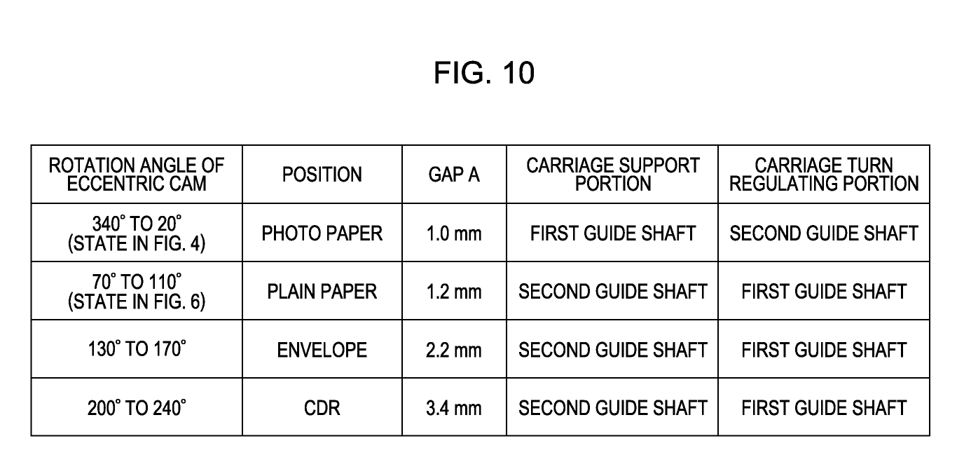

FIG. 10 is a table showing the relationships among the carriage position, gap, eccentric cam phase, etc. The highest image recording quality is required when recording is performed on photo paper. In this case, the gap A is set at 1.0 mm. The position of the carriage 32 in the height direction is defined by the first guide shaft 33, and the turning of the carriage 32 is regulated by the second guide shaft 34. Since the first guide shaft 33 close to the platen 24 is fixed to the chassis 9, a high accuracy of ink landing can be maintained.

When the eccentric cam 34a is rotated 90° in the direction of arrow C in the state shown in FIG. 4, the state shown in FIG. 6 in which the gap A between the recording head 31 and the platen 24 is large can be brought about. In this case, the position of the carriage 32 in the height direction is defined by the second guide shaft 34, and the turning of the carriage 32 is regulated by the first guide shaft 33, as described above. The space 35b is provided between the first guide shaft 33 and the first bearing 32a. In this case, the gap A is set at 1.2 mm, and recording is performed on plain paper. In contrast to recording on photo paper, the amount of displacement of the landing position of ink on the recording medium increases slightly, since the second guide shaft 34 urged by springs against the chassis 9 is used to support the carriage 32.

When the eccentric cam 34a is rotated 150° in the direction of arrow C in the state shown in FIG. 4, the state shifts to a state that is suitable for recording on thick paper like an envelope. In this state, similarly, the position of the carriage 32 in the height direction is defined by the second guide shaft 34, and the space 35b is provided between the first guide shaft 33 and the first bearing 32a. The gap A is set at 2.2 mm.

When the eccentric cam 34a is rotated 220° in the direction of arrow C in the state shown in FIG. 4, the state shifts to a state that is suitable for recording on a disk-shaped recording medium like a CD-R. In this state, similarly, the position of the carriage 32 in the height direction is defined by the second guide shaft 34, and the space 35b is provided between the first guide shaft 33 and the first bearing 32a. The gap A is set at 3.4 mm.

### Second Embodiment

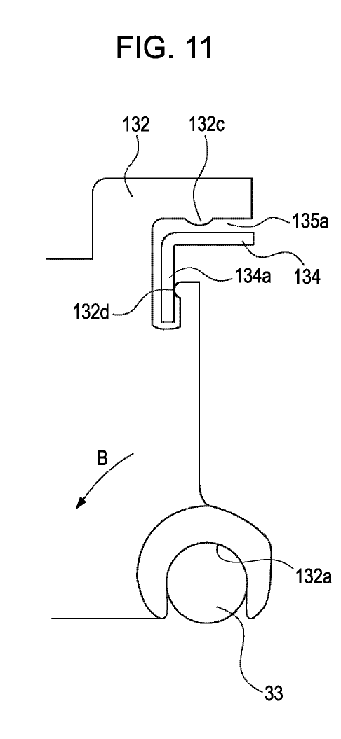

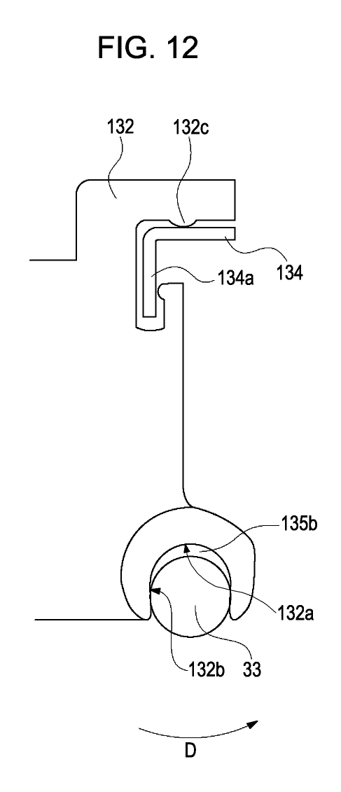

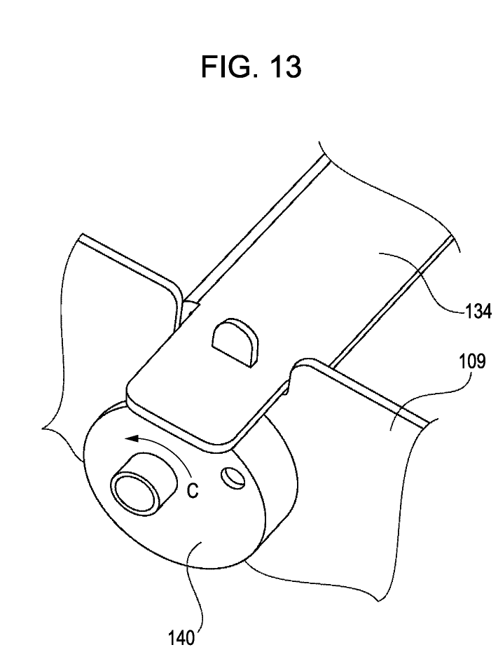

A second embodiment of the present invention will now be described with reference to FIGS. 11 to 13. FIG. 11 is a cross-sectional view of an inkjet recording apparatus when the gap between a recording head and a platen is small. FIG. 12 is a cross-sectional view of the inkjet recording apparatus when the gap between the recording head and the platen is large. FIG. 13 explains a structure for moving a guide rail up and down in the second embodiment.

In the first embodiment, the first guide shaft 33 serves as the first support member, and the second guide shaft 34 serves as the second support member. In contrast, the second embodiment is characterized in that a plate-shaped guide rail 134 serves as the second support member.

In a state shown in FIG. 11 in which the gap between a recording head and a platen is small, the position of a carriage 132 in the height direction is determined by the contact of the top of a first guide shaft 33 with the top of a first bearing 132a of the carriage 132 in the height direction. In this case, the gap between the recording head and the platen is set at 1.0 mm. Further, the top of the guide rail 134 serving as the second support member is separate from a second engaging portion 132c of the carriage 132, thereby forming a space 135a therebetween. In this case, the turning of the carriage 132 around the first guide shaft 33 in the direction of arrow B in FIG. 11 is regulated by the contact of a turn regulating portion 132d of the carriage 132 with a vertical portion 134a of the guide rail 134.

Eccentric cams 140 are in contact with either end of the guide rail 134. The guide rail 134 is urged against the eccentric cams 140 by springs (not shown). The driving force of a carriage lifting motor is transmitted to the eccentric cams 140 via predetermined gear trains, and the eccentric cams 140 are thereby rotated to move the guide rail 134 up and down.

When the eccentric cams 140 are rotated in the direction of arrow C in FIG. 13 in the state shown in FIG. 11 in which the gap between the recording head and the platen is small, the state shifts to a state in which the gap is large, as shown in FIG. 12.

In the state shown in FIG. 12 in which the gap between the recording head and the platen is large, the position of the carriage 132 in the height direction is determined by the contact of the top of the guide rail 134 with the second engaging portion 132c of the carriage 132 in the height direction. In this case, the gap between the recording head and the platen is set at 1.2 mm. Further, the top of the first guide shaft 33 is separate from the top of the first bearing 132a in the height direction, thus forming a space 135b therebetween. In this case, the turning of the carriage 132 around the guide rail 134 in the direction of arrow D in FIG. 12 is regulated by the contact of a turn regulating portion 132b of the first bearing 132a with the first guide shaft 33.

As described above, the first guide shaft 33 close to the platen is fixed to a chassis 109, and the guide rail 134 remote from the platen moves up and down, so that the gap between the recording head and the platen can be changed.

The first support member can be formed by a plate-shaped guide rail, and the second support member can be formed by a guide shaft. Alternatively, both the first and second support members can be formed by guide rails.

In the recording apparatuses according to the above-described embodiments of the present invention, high-quality image printing can be performed by changing the position of the recording head relative to the platen for holding the recording medium so as to change the gap therebetween.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-269159 filed Oct. 16, 2007, which is hereby incorporated by reference herein in its entirety.

What is claimed is:

1. An inkjet recording apparatus comprising:
a movable carriage having a recording head configured to perform recording by discharging ink onto a recording medium;
a platen configured to support the recording medium at a position facing the recording head;
a first support member fixed to a chassis, and configured to guide the motion of the carriage; and
a second support member provided farther from the platen than the first support member, and configured to guide the motion of the carriage in conjunction with the first support member,
wherein a gap between the recording head and the platen is changed by moving the second support member in a direction intersecting a surface of the platen for supporting the recording medium.

2. The inkjet recording apparatus according to claim 1,
wherein a position of the carriage in the direction intersecting the surface of the platen for supporting the recording medium is determined by the first support member when the gap between the recording head and the platen is a first gap, and
wherein the position of the carriage in the direction intersecting the surface of the platen for supporting the recording medium is determined by the second support member when the gap between the recording head and the platen is a second gap larger than the first gap.

3. The inkjet recording apparatus according to claim 2,
wherein turning of the carriage around the first support member is regulated by the second support member when the gap between the recording head and the platen is the first gap, and
wherein turning of the carriage around the second support member is regulated by the first support member when the gap between the recording head and the platen is the second gap.

4. The inkjet recording apparatus according to claim 1, further comprising:
a motor configured to move the second support member in the direction intersecting the surface of the platen for supporting the recording medium.

5. The inkjet recording apparatus according to claim 4, wherein a driving force of the motor is transmitted to an eccentric cam provide at an end of the second support member.

6. The inkjet recording apparatus according to claim 5, further comprising:
a spring configured to urge the second support member.

7. The inkjet recording apparatus according to claim 1, wherein the first support member is fixed to the chassis by a screw.

8. The inkjet recording apparatus according to claim 1, wherein the first support member is a shaft.

9. The inkjet recording apparatus according to claim 8, wherein the second support member is a shaft.

10. The inkjet recording apparatus according to claim 8, wherein the second support member is a guide rail.

11. The inkjet recording apparatus according to claim 1, wherein the first support member is a guide rail.
